(19) United States
(12) Patent Application Publication
(10) Pub. No.: US 2013/0054865 A1
(43) Pub. Date: Feb. 28, 2013

(54) MOUSE

(71) Applicants: XIAO-GANG YIN, Shenzhen City (CN); YUNG-CHIEH CHEN, Tu-Cheng (TW)

(72) Inventors: XIAO-GANG YIN, Shenzhen City (CN); YUNG-CHIEH CHEN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (TW)

(21) Appl. No.: 13/285,028

(22) Filed: Oct. 31, 2011

(30) Foreign Application Priority Data
Aug. 24, 2011 (CN) 201110243357.9

(51) Int. Cl. G06F 13/20

(52) U.S. Cl. 710/313

(57) ABSTRACT

A mouse includes a universal serial bus (USB) 3.0 port, a mouse control circuit, and a memory card port for connecting a memory card. The USB 3.0 port transmits data of the mouse from the mouse control circuit through a first to a fourth pins of the USB 3.0 port, and transmits data of the memory card through the first and a fifth to ninth pins of the USB 3.0 port.

### BACKGROUND

1. Technical Field

The present disclosure relates to a computer mouse.

2. Description of Related Art

The transmission speed of a universal serial bus (USB) 3.0 is ten times faster than a USB 2.0. The USB 3.0 has been used in many electronic devices, such as a computer mouse, for communication. However, having a personal computer using a mouse with a USB 3.0 interface, only, for data transmission between the mouse and the computer wastes bandwidth.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a mouse.

FIG. 2 is an isometric view of the mouse of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

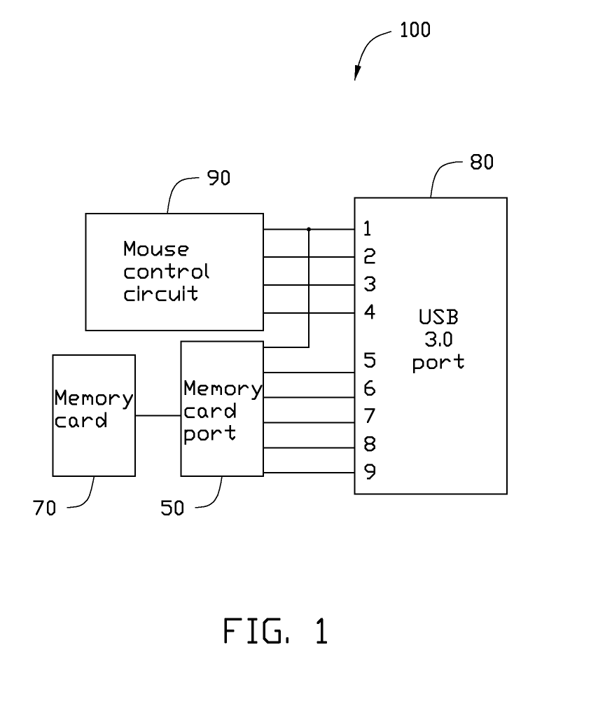

Referring to FIG. 1, an exemplary embodiment of a mouse 100 includes a universal serial bus (USB) 3.0 port 80, a mouse control circuit 90, a memory card 70, and a memory card port 50 connected to the memory card 70.

The port 80 includes pins 1-9. According to the USB 3.0 standard, pins 1-4 connected to the mouse control circuit 90 function as four pins of a USB 2.0 port. Pin 1 functions as a power supply terminal. Pins 2 and 3 are used for receiving or sending a pair of differential signals, and the pin 4 is a ground terminal Pins 5 and 6 are configured for receiving a pair of differential signals. Pin 7 is a ground terminal. Pins 8 and 9 are configured for sending a pair of differential signals. Pins 1 and 5-9 are connected to the memory card port 50.

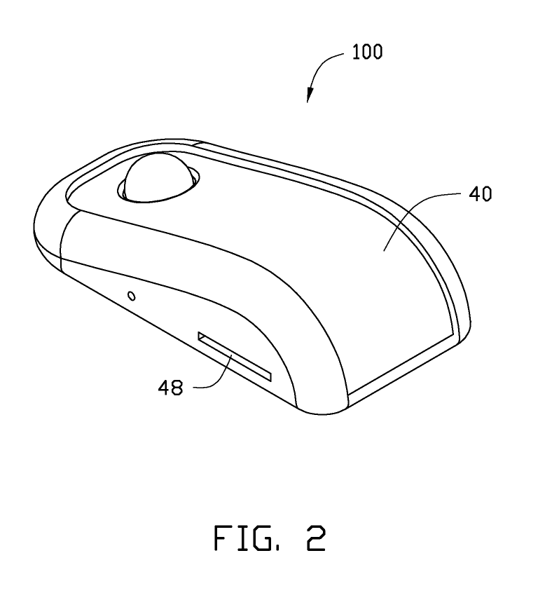

Referring to FIG. 2, the mouse 100 further includes a shell 40 enclosing the USB 3.0 port 80, the mouse control circuit 90, and the memory port 50. The shell 40 defines a slot 48 in a sidewall of the shell 40. In this embodiment, the memory card 70 enters the shell 40 to engage with the memory card port 50 through the slot 48. In other embodiments, the slot 48 can be defined in other parts of the shell 40, such as the top surface.

The USB 3.0 port 80 can transmit data of the mouse 100 from the mouse control circuit 90 through the pins 1-4, and transmit data of the memory card 70 through the pins 1 and 5-9 simultaneously.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A mouse comprising:
a universal serial bus (USB) port, comprising a first to a ninth pins, wherein the first pin functions as a power supply terminal, the second and third pins are used for sending or receiving a pair of differential signals, the fourth and the seventh pins are ground terminals, the fifth and the sixth pins are used for receiving a pair of differential signals, the eighth and the ninth pins are used for sending a pair of differential signals;
a mouse control circuit connected to the first to fourth pins of the USB port; and
a memory card port connected to the first, and the fifth to ninth pins of the USB port.

2. The mouse of claim 1, further comprising a memory card connected to the memory card port.

3. The mouse of claim 1, further comprising a shell enclosing the USB port, the mouse control circuit, and the memory card port, wherein the shell defines a slot, the memory card enters the shell to engage with the memory card port through the slot.
